(19) United States
(12) Patent Application Publication
(10) Pub. No.: US 2006/0101959 A1
(43) Pub. Date: May 18, 2006

(54) Cutting board apparatus and method

(76) Inventor: Phillip Jeska, Prospect Heights, IL (US)

Correspondence Address: WILDMAN HARROLD ALLEN & DIXON, 225 WEST WACKER DRIVE, SUITE 2800, CHICAGO, IL, 60606, US

(21) Appl. No.: 10/989,018

(22) Filed: Nov. 15, 2004

(51) Int. Cl. B27B 11/00

(52) U.S. Cl. 83/13; 83/743

(57) ABSTRACT

A cutting board apparatus comprises opposing surfaces, including a cutting surface and a serving surface. The apparatus further comprises at least one handle adapted to support the cutting board apparatus on a flat surface (when the cutting surface is in use) and to serve as a gripping member (when the serving surface is in use). In select embodiments, the at least one handle includes a first portion extending away from the cutting board apparatus and a second portion transverse to the first portion, such that an open space is defined between the second portion and a plane of the serving surface.

### FIELD OF THE INVENTION

This invention relates to implements adapted to receive and hold food, and more particularly to a cutting board apparatus and method of use therefor.

### SUMMARY OF THE INVENTION

In one embodiment, the present invention is directed to a cutting board apparatus comprising opposing surfaces, including a first surface and a second surface, wherein the first surface includes a substantially planar portion and the second surface includes a recessed portion defined by the second surface and positioned within a central portion of the second surface and at least one handle comprising a first portion secured to and projecting away from the apparatus and a second portion transverse to the first portion.

In another embodiment, the present invention is directed to a cutting board apparatus comprising opposing surfaces, including a cutting surface and a serving surface, at least one handle comprising a first portion secured to the apparatus and a second portion transverse to the first portion, wherein the second portion and a plane of the serving surface define an open space therebetween, and wherein the at least one handle is used as a gripping member when the serving surface is in use and as a support member that rests on a flat surface when the cutting surface is in use, such that the cutting surface is positioned in a substantially parallel relationship with the flat surface when the cutting surface is in use.

In yet another embodiment, the present invention is directed to a method, comprising the steps of providing an apparatus comprising a serving surface on one side, a cutting surface on an opposing side and at least one handle, the at least one handle comprising a first portion secured to the apparatus and a second portion transverse to the first portion, placing a first food item on the serving surface, turning the apparatus over and resting the at least one handle on a flat surface for use of the cutting surface and cutting a second food item on the cutting surface.

### BRIEF DESCRIPTION OF THE DRAWINGS

Certain embodiments of the presently claimed invention are illustrated by the accompanying figures. It should be understood that the figures are not necessarily to scale and that details not necessary for an understanding of the invention or that render other details difficult to perceive may be omitted. It should be understood, of course, that the invention is not necessarily limited to the particular embodiments illustrated herein.

FIG. 1 is a perspective view of one embodiment of the cutting board apparatus of the present invention resting on a flat surface, with cutting surface oriented in an upward direction;

FIG. 2 is a side elevational view of the embodiment of the invention in FIG. 1;

FIG. 3 is a perspective view of the embodiment of the invention in FIG. 1, with serving surface oriented in an upward direction;

FIG. 4A is a partial break away view of a second embodiment of the present invention;

FIG. 4B is a side elevational view of the second embodiment of the present invention of FIG. 4A; and

FIG. 5 is a perspective view of a third embodiment of the present invention.

### DETAILED DESCRIPTION

The present invention relates to a cutting board apparatus comprising opposing surfaces, including a first surface and a second surface, and at least one handle. The first surface may be employed as a cutting surface while the second surface may be employed as a serving surface. Thus, the opposing surfaces allow the cutting board apparatus of the present invention to serve dual purposes—as (1) a cutting board and (2) a serving tray. As used herein, the term “opposing” means on reverse sides, such that the apparatus may be turned over and used on either of the first and second surfaces.

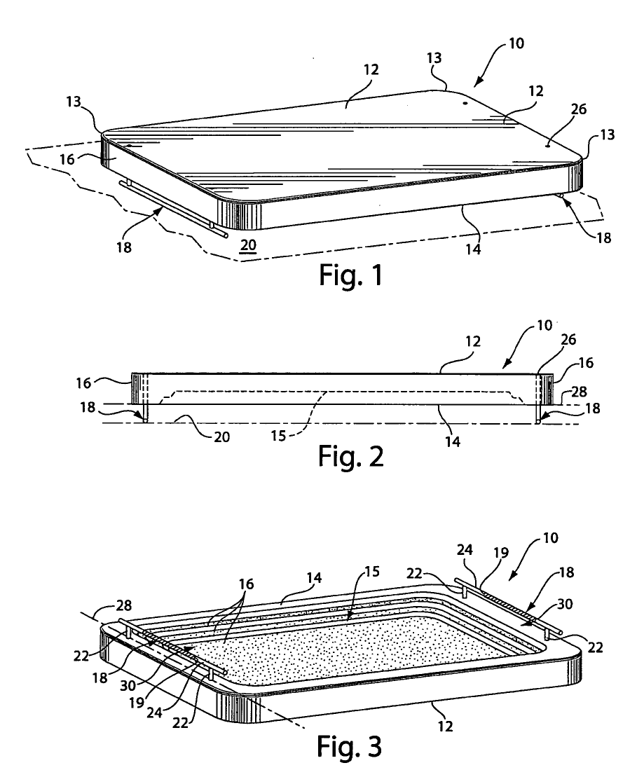

In one aspect, the present invention is directed to a cutting board apparatus. Referring now to FIG. 1, one embodiment of the cutting board apparatus 10 of the present invention is shown. Cutting board apparatus 10 includes cutting surface 12, which is generally planar in construction to provide ease in cutting vegetables, fruits and other food items and is generally parallel to flat surface 20 upon which cutting board apparatus 10 rests. Corners 13 of cutting board apparatus of 10 may be curved and include a radius of curvature between about 1.0 inch to about 4.0 inches, and more suitably between about 2.0 inches and 3.0 inches.

As shown in FIG. 2, sidewalls 16 of the cutting board apparatus 10 are positioned between cutting and serving surfaces 12 and 14. Two spaced handles 18 extend from serving surface 14 of cutting board apparatus 10 and serve as legs to support cutting board apparatus 10 with cutting surface 12 facing upward.

Referring to FIG. 3, serving surface 14 includes a recessed portion 15, defined by serving surface 14 and positioned within a central portion of serving surface 14. Recessed portion 15 is designed to provide a cradled area for carving and serving large food items, especially meat, fish or poultry and is adapted to receive a fluid associated with a food item to direct the fluid from the food item to a central portion of serving surface 14. Recessed portion 15 may further comprise a plurality of successively recessed portions 16. Recessed portion 15 may also include a radius of curvature between about 1.5 inches and 3.0 inches.

Cutting and serving surfaces 12 and 14 are typically constructed of wood and handles 18 are typically constructed of wood, brass or stainless steel. Other materials known to those of skill in the art may, however, be employed. When handles 18 are constructed of wood, they may be wrapped with a gripping surface 19.

Handles 18 are adapted to support cutting board apparatus 10 on a flat surface 20 (when the cutting surface 12 is in use, FIG. 1) and to serve as gripping members (when the serving surface 14 is in use, FIG. 3). As shown in FIGS. 3 and 5, handles 18 may comprise a first portion 22 secured to and projecting away from the cutting board apparatus 10 and a second portion 24 transverse to first portion 22. As used herein, the term transverse means intersecting at some point.

Handles 18 may take alternate forms, described hereinafter. In the forms shown herein, the second portion 24 and a plane 28 of the serving surface 14 define an open space 30 therebetween.

Referring now to FIGS. 2 and 3, two-spaced apart handles 18 are disposed on serving surface 14. The handles 18 comprise first portion 22, projecting away from cutting board apparatus 10 and second portion 24 transverse to first portion 22. An open space 30 is positioned between second portion 24 and the plane 28 of serving surface 14.

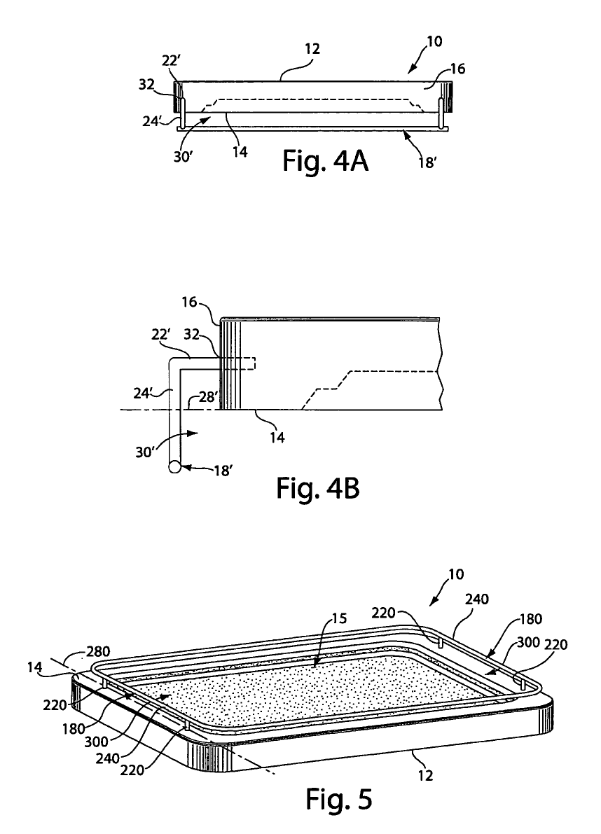

An alternate embodiment is shown in FIG. 4. In this embodiment, at least one L-shaped spaced-apart handle 18′ is secured to sidewall 16 of cutting board apparatus 10. The L-shaped handle 18′ comprises a securing portion 32, a first portion 22′, projecting away from the serving surface 14 and a second portion 24′ transverse to the first portion 22′. Second portion 24′ and a plane 28′ of serving surface 14 define an open space 30′ therebetween.

Rather than two spaced-apart handles, a handle of unitary construction may be employed. As shown in FIG. 5, unitary handle 180, comprising first portion 220 and second portion 240, extends around the perimeter of serving surface 14. Second portion 240 of unitary handle and a plane 280 of serving surface 14 define an open space 300 therebetween.

In another aspect, the present invention is directed to methods of use. In one embodiment, the method comprises various steps. First, one of the embodiments of cutting apparatus 10 described above is provided. Next, a first food item is placed on either cutting surface 12 or serving surface 14. If cutting surface 12 is to be used, typically the second portion 24 of the at least one handle 18 is positioned on a flat surface. The structure of handles 18 allows the user to slide a plate or small bowl under the serving surface 14 to collect the first food item after it is cut on cutting surface 12. If serving surface 14 is to be used, typically the at least one handle 18 is positioned to be grasped by a server and the apparatus 10 is used as a serving tray. After finishing with the first food item, the cutting board apparatus 10 is turned over and a second food item is placed on the opposing surface. The first and second food items may or may not be the same.

In yet another aspect, the present invention is directed to methods for making the cutting boards described herein. Generally, wooden boards are cut to the appropriate dimensions and handles attached thereto.

The wooden boards are typically created from wood or a wood-like material through a series of processing steps. In one embodiment, hardwood boards are glued into slabs using food service compliant glue. These slabs are dried in a mechanical press or clamping device until the glue is fully cured. Any rough edges on opposing surfaces of the boards are substantially smoothed by machine processing. A number of these slabs are then typically glued face-to-face to create a block, which is again dried in a mechanical press or clamping device. The fully cured block may then be cut across the grain to create boards of desired thickness to display the end grain of the block from which it has been cut. The end grain board can then be cut into the final product in terms of final dimensions and desired surface finish.

Handles 18 may be secured to a surface of the cutting board apparatus 10 in various ways. In one aspect, handles 18 may be secured to one of sidewalls 16 or serving surface 14. In another aspect, securement may be accomplished through a mounting hole/fastener arrangement. Under this arrangement, handles 18 and serving surface 14 or sidewalls 16 comprise alignable mounting holes 26 adapted to receive fasteners for attaching handles 18 to cutting board apparatus 10. A countersink arrangement adapted to receive screws for securing handles 18 may be drilled into appropriate locations on a surface of the cutting board apparatus 10. Alternatively or additionally, food service compliant adhesives, applied to handles 18 and a surface of cutting board apparatus 10 may be employed. Other securements known to those of skill in the art may also be employed.

Variations, modifications and other implementations of what is described herein will occur to those of ordinary skill in the art without departing from the spirit and scope of the invention. Accordingly, the invention is in no way limited by the preceding illustrative description.

What is claimed is:

1. A cutting board apparatus, comprising:
opposing surfaces, including a first surface and a second surface, wherein the first surface includes a substantially planar portion and the second surface includes a recessed portion defined by the second surface and positioned within a central portion of the second surface; and
at least one handle comprising a first portion secured to and projecting away from the apparatus and a second portion transverse to the first portion.

2. The apparatus of claim 1, wherein the second portion and a plane of the second surface define an open space therebetween.

3. The apparatus of claim 1, wherein the first surface is a cutting surface and the second surface is a serving surface.

4. The apparatus of claim 1, wherein the first and second surfaces are constructed of wood and the handle is constructed of metal.

5. The apparatus of claim 1, wherein the second surface is adapted to receive a fluid associated with a food item and the recessed portion directs the fluid from the food item to the central portion of the second surface.

6. The apparatus of claim 1, wherein the first portion of the at least one handle is secured to the second surface.

7. The apparatus of claim 1, wherein the first portion of the at least one handle is secured to a sidewall disposed between the first and second surfaces.

8. The apparatus of claim 1, further comprising a second handle spaced apart from the at least one handle.

9. A cutting board apparatus, comprising:
opposing surfaces, including a cutting surface and a serving surface;
at least one handle comprising a first portion secured to the apparatus and a second portion transverse to the first portion, wherein the second portion and a plane of the serving surface define an open space therebetween;
wherein the at least one handle is used as a gripping member when the serving surface is positioned for use and as a support member that rests on a flat surface when the cutting surface is positioned for use, such that the cutting surface is positioned in a substantially parallel relationship with the flat surface with the cutting surface is positioned for use.

10. The apparatus of claim 9, wherein the serving surface includes a recessed portion defined by the serving surface and positioned within a central portion of the serving surface.

11. The apparatus of claim 10, wherein the serving surface is adapted to receive a fluid associated with a food item and the recessed portion directs the fluid from the food item to a central portion of the second surface.

12. The apparatus of claim 10, wherein the recessed portion includes a plurality of successively recessed portions.

13. The apparatus of claim 9, wherein the second portion and a plane of the serving surface define an open space therebetween.

14. A method, comprising the steps of:
providing an apparatus comprising a serving surface on one side, a cutting surface on an opposing side and at least one handle, the at least one handle comprising a first portion secured to the apparatus and a second portion transverse to the first portion;
placing a first food item on the serving surface;
turning the apparatus over and resting the at least one handle on a flat surface for use of the cutting surface; and
cutting a second food item on the cutting surface.

15. The method of claim 14, wherein the first portion of the at least one handle is secured to the second surface.

16. The method of claim 14, wherein the first portion of the at least one handle is secured to a sidewall disposed between the first and second surfaces.

17. The method of claim 14, wherein the first and second food items are the same food items.

18. The method of claim 14, wherein the second portion and a plane of the serving surface define an open space therebetween.

19. The method of claim 14, wherein a portion of the serving surface includes a recess defined by the serving surface and positioned within a central portion of the serving surface.

20. The method of claim 14 further comprising serving the first food item after the placing step.

21. The method of claim 14, wherein a corner of cutting board apparatus includes a radius of curvature between about 1.0 and 4.0 inches.
